(19) United States
(12) Patent Application Publication
(10) Pub. No.: US 2020/0074277 A1
(43) Pub. Date: Mar. 5, 2020

(54) FUZZY INPUT FOR AUTOENCODERS

(71) Applicant: Ford Global Technologies, LLC, Dearborn, MI (US)

(72) Inventor: Bruno Sielly JALES COSTA, Dearborn, MI (US)

(21) Appl. No.: 16/466,118

(22) PCT Filed: Dec. 2, 2016
(86) PCT No.: PCT/US16/64662

§ 371 Date: Jun. 3, 2019

(51) Int. Cl. G06N 3/04; G06N 3/08

(52) U.S. Cl. CPC G06N 3/0436; G06N 3/084; G06N 3/0454

(57) ABSTRACT

Systems, methods, and devices for reducing dimensionality and improving neural network operation in light of uncertainty or noise are disclosed herein. A method for reducing dimensionality and improving neural network operation in light of uncertainty or noise includes receiving raw data including a plurality of samples, wherein each sample includes a plurality of input features. The method includes generating fuzzy data based on the raw data. The method includes inputting the raw data and the fuzzy data into an input layer of a neural network autoencoder.

### TECHNICAL FIELD

The disclosure relates generally to methods, systems, and apparatuses for training and using neural networks and more particularly relates to providing fuzzy input to neural networks having one or more autoencoder layers.

### BACKGROUND

The curse of dimensionality has been a very well-known problem for a variety of engineering applications for the last few decades. Dimensionality reduction techniques, thus, play a very important role in many fields of study, especially in the era of big data and real-time applications. The recently introduced concept of ‘autoencoders’ have gained considerable attention and obtained very promising results. However, similarly to the traditional neural networks, autoencoders are deterministic structures that are not very suitable for dealing with data uncertainty, a very important aspect of the real-world applications.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating a fuzzification layer, according to one implementation;

FIG. 2 is a graphical diagram illustrating data points and clusters, according to one implementation;

FIG. 3 is a graphical diagram illustrating clusters, according to one implementation;

FIG. 4 is a graphical diagram illustrating clusters and corresponding membership functions, according to one implementation;

FIG. 5 is a schematic diagram illustrating an autoencoder, according to one implementation;

FIG. 6 is a schematic diagram illustrating creation of a deep stack of autoencoders, according to one implementation;

FIG. 7 is a schematic diagram illustrating a fuzzy deep stack of autoencoders, according to one implementation;

FIG. 8 is a schematic flow chart diagram illustrating a method for training and processing data using a neural network with fuzzy input, according to one implementation; and

FIG. 9 is a schematic block diagram illustrating example components of a neural network processing component 900, according to one implementation;

FIG. 10 is a schematic flow chart diagram illustrating a method for training and processing data using a neural network with fuzzy input, according to one implementation; and

FIG. 11 is a schematic flow chart diagram illustrating a method for training and processing data using a neural network with fuzzy input, according to one implementation; and

FIG. 12 is a schematic flow chart diagram illustrating a method for training and processing data using a neural network with fuzzy input, according to one implementation; and

FIG. 13 is a schematic block diagram illustrating a computing system, according to one implementation.

### DETAILED DESCRIPTION

Applicants have developed systems, methods, and devices that take advantage of fuzzy systems in order to handle uncertainties in data. In one embodiment, fuzzified inputs can be added to a regular autoencoder using a prior executed fuzzification step. Proposed multi-model autoencoders may be able to fuse crisp inputs and automatically generated fuzzy inputs.

According to one example embodiment, a system, device, or method for reducing dimensionality and improving neural network operation in light of uncertainty or noise receives raw data including a plurality of samples, wherein each sample includes a plurality of input features. The method includes generating fuzzy data based on the raw data. The system, device, or method inputs the raw data and the fuzzy data into an input layer of a neural network autoencoder.

According to another example embodiment, a system, device, or method determines an activation level based on a sample for at least one membership function, wherein the membership function corresponds to a group or cluster determined based on training data. The system, device, or method inputs features for a sample into a first set of input nodes of a neural network, wherein the neural network includes one or more autoencoder layers and an input layer including the first set of input nodes and a second set of input nodes. The system, device, or method inputs the activation level into the second set of input nodes of the neural network.

According to yet another embodiment, a system includes a training data component, a clustering component, a membership function component, an activation level component, a crisp input component, and a fuzzy input component. The training data component is configured to obtain raw data including a plurality of training samples. The clustering component is configured to identify a plurality of groups or clusters within the raw data. The membership function component is configured to determine a plurality of membership functions, wherein the plurality of membership functions include a membership function for each of the plurality of groups or clusters. The activation level component is configured to determine an activation level for at least one membership function based on features of a sample. The crisp input component is configured to input features of the sample into a first set of input nodes of an autoencoder. The fuzzy input component is configured to input the activation level into a second set of input nodes of the autoencoder.

An autoencoder is a special case of neural network that aims to copy its input to its output. It has one input layer, one hidden layer and one output layer. The number of units in the hidden layer, by definition, is lower than in the input and output layers. Input and output layers have the same size. See FIG. 5 illustrating a generic representation of an autoencoder. Autoencoders have been used for, among other tasks, unsupervised learning, feature extraction, dimensionality reduction, and data compression. An autoencoder is generally used to build an output as similar as possible to an input from a compressed representation (e.g., the layer having the lower number of inputs). Its structure allows easy stacking for creation of deep autoencoder networks. Alternatively, an autoencoder might be used as part of other structures, such as classifiers, with the addition of a sequential layer for supervised learning.

One of the main problems of the standard neural networks is the inability of handling data uncertainty, even though mechanisms for stochastic behaviors are often used. Given the characteristics of fuzzy systems for dealing with data uncertainties, at least some embodiments propose an extended structure for an autoencoder that improves the compressed representation of the input, especially when dealing with noisy data, by adding a number of inputs. The added inputs are artificially generated using a fuzzification process, at or before a first layer (or input layer) of an autoencoder. At least some embodiments may be used in many configurations and transparently replace any traditional autoencoder.

In one embodiment, the original crisp inputs (raw or original data as received) feed the first layer of the autoencoder, as usual. However, these inputs also feed a fuzzy system with structure determined by the output of a clustering algorithm. The output of the fuzzy system is also used as input to the first layer of the autoencoder, resulting in a transparent substitute for a traditional autoencoder (same interface), although much more suitable for uncertain data. In one embodiment, a set of the proposed autoencoders (or layers trained using an autoencoder) can be seamlessly stacked as a deep neural network (DNN) structure with one or more additional layers for performing an applicable classification task. Embodiments disclosed herein provide significant benefits. For example, results for classification tasks are substantially improved with proposed structures, especially for noisy test data.

Further embodiments and examples will be discussed in relation to the figures below.

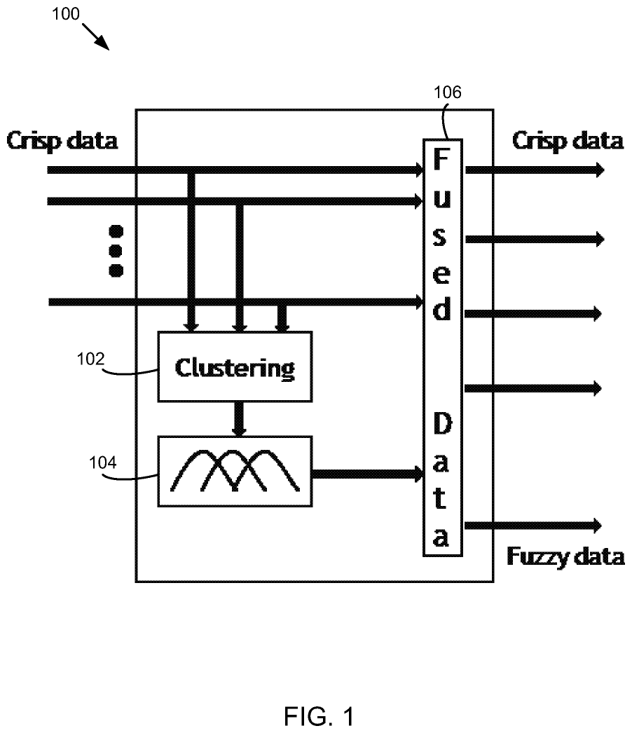

FIG. 1 is a schematic block diagram illustrating a fuzzification layer 100 which may be used to input crisp data and fuzzy data into an input layer of an autoencoder or other neural network. The fuzzification layer 100 may receive crisp data. The crisp data may include sensor data or other data to be processed by a neural network, such as for classification. Clustering 102 is performed on the crisp data (which may include a large set of labeled or unlabeled training samples) and membership functions are generated 104 describing the clusters. In one embodiment, clustering 102 and generation 104 of membership functions is performed separately and information about the membership functions is used to generate fuzzy input.

During training and/or usage of a neural network, the fuzzification layer 100 may receive the features of a single sample as crisp data. Based on the crisp data the membership functions 104 are used to generate an activation level for each membership function. The fused data 106 of the fuzzification layer 100 may be output. The fused data may include the original crisp data features as well as one or more additional fuzzy data inputs. For example, if each sample includes 50 features, the fuzzification layer 100 may determine 5 fuzzy features. The 50 features of the sample as well as the 5 fuzzy features are output by the fuzzification layer 100 to input nodes of an autoencoder or other neural network. The additional fuzzy inputs generated by the fuzzification layer 100 may require a larger autoencoder or number of input nodes (e.g., 55 versus 50 in the above example), but the resulting quality of output, as well as the reduction in dimensionality provided by one or more autoencoder layers, may provide a net improvement in both efficiency and quality of output. For example, a neural net including autoencoder layers that uses fuzzy input may have increased robustness with regard to noise or uncertain data.

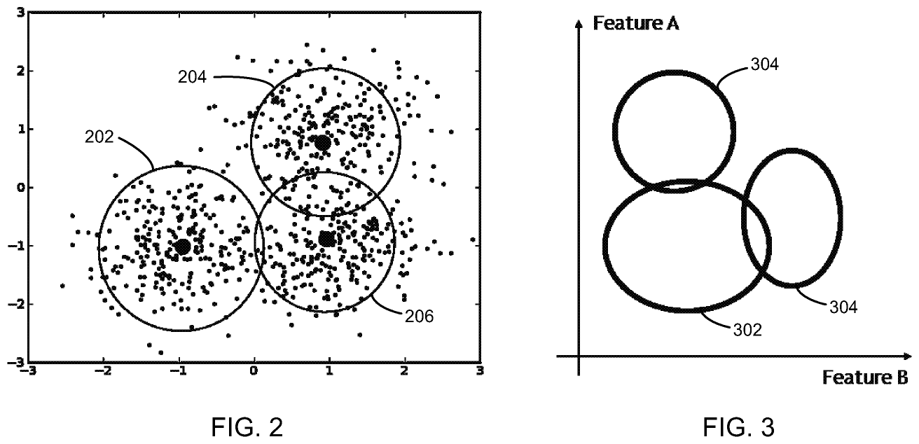

A fuzzification process performed by the fuzzification layer 100 may include two general steps: (1) spatially grouping or clustering data in the training set; and (2) generation of membership functions for the groupings or clusters. FIG. 2 illustrates grouping of training samples. Specifically, 2-dimensional samples (e.g., samples with two features each) are shown as dots with respect to a vertical and horizontal axis. A clustering or grouping algorithm or process may identify the first cluster 202, second cluster 204, and the third cluster 206 of samples. The number of samples may be automatically determined based on the data or may be specified by a user. There are numerous known clustering algorithms which may be used in various embodiments such as partitioning based clustering algorithms, data mining clustering algorithms, hierarchical based clustering algorithms, density based clustering algorithms, model based clustering algorithms, grid based clustering algorithms, and the like. Example clustering algorithms include K-means, fuzzy clustering, density-based spacial clustering of applications with noise (DBSCAN), K-mediods, balanced iterative reducing and clustering using hierarchies (BIRCH), or the like. The type of clustering used may depend on the type of data, the desired use of the data, or any other such consideration. In one embodiment, clustering is performed separately on a large amount of labeled and/or unlabeled data to generate clusters in advance of training of an autoencoder network or layer. As a result of a clustering algorithm, the centers of the clusters and a diameter or width in one or more dimensions may be found. The center and/or the widths may be used to create fuzzy membership functions.

FIG. 3 illustrates a graph of three clusters which may result from a clustering algorithm performed on training data. The three clusters include a first cluster 302, a second cluster 304, and a third cluster 306 shown with respect to a vertical axis representing feature A and a horizontal axis representing feature B. The clusters 302, 304, 306 are shown without points representing the samples for clarity. For illustrative purposes, only two dimensions are shown. However, the principles and embodiments disclosed herein also apply to many dimensional data sets with tens, hundreds, thousands, millions, or any other number of features. Based on the clusters 302, 304, 306, membership functions may be generated. Again, membership functions may be generated in advance of training of a neural network based on a large body of training data including labeled and/or unlabeled samples.

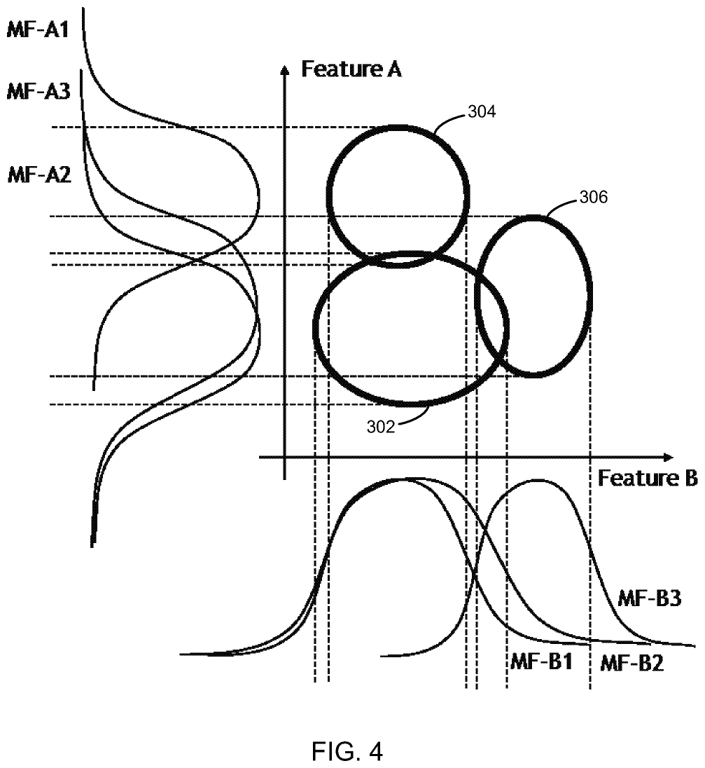

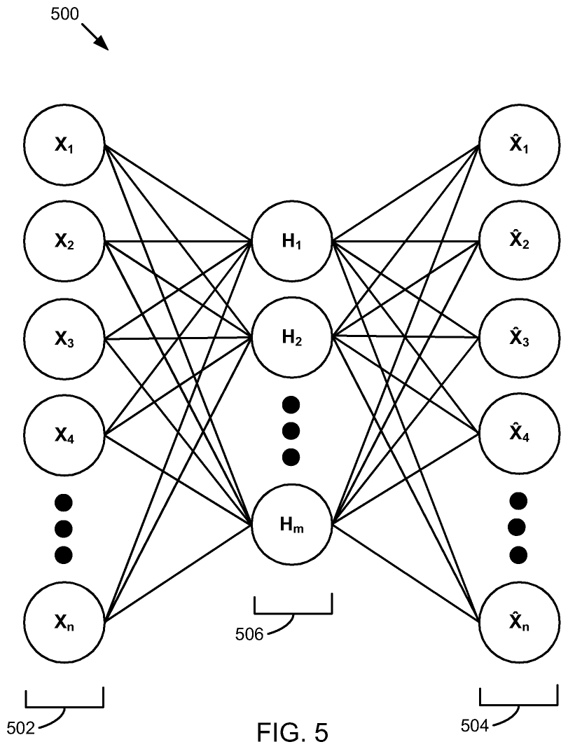

FIG. 4 graphically illustrates membership functions which may be generated based on the clusters 302, 304, and 306 of FIG. 3. In one embodiment, the clustering information may be converted into membership functions. For example, the first cluster 302 may be converted into membership functions including equations for MF-A2 and MF-B2, the second cluster 304 may be converted into membership functions including MF-A1 and MF-B1, and the third cluster 306 may be converted into membership functions including equations for MF-A3 and MF-B3, as shown. FIG. 4 depicts the membership functions as Gaussian functions because they match the oval shapes of the clusters. However, any type of membership function may be used (e.g. triangular, trapezoidal, bell, Cauchy, square, or the like). The centers of the membership functions match the centers of the clusters in each of the dimensions. As previously discussed, the illustrated example is for 2-dimensinoal data (Features A and B) but can be applicable to any dimensionality and any number of clusters.

Based on the membership functions, an activation level of a specific sample may be determined. In one embodiment, rules for determining the activation level may be specified. For the presented example of FIGS. 3 and 4 we can create as many as 9 fuzzy rules (i.e. 9 fuzzy inputs to the neural network in addition to the 2 already existing). These example fuzzy rules may be structured as follows: 1) if feature A is MF-A1 and feature is MF-B1 then ( . . . ); 2) if feature A is MF-A1 and feature is MF-B2 then ( . . . ); 3) if feature A is MF-A1 and feature is MF-B3 then ( . . . ); . . . ; and 9) if feature A is MF-A3 and feature is MF-B3 then ( . . . ). In most of the cases, the maximum number of possible rules is not necessary. The output of each rule, marked as ( . . . ) in the previous slide is the activation degree of the rule. Each rule is activated by the values of the input regarding to the membership functions.

By way of example, for the given rule if feature A is MF-A1 and feature is MF-B1 then ( . . . ), if the value of feature A for a sample lies exactly on the center of the second cluster 304 and the value of the feature B for the sample lies exactly on the center of the second cluster 304, then the activation of the rule may be very close to or equal to 1 (maximum membership). On the other hand, if the sample values lie very far away for both centers, the activation degree may be very close or equal to 0 (minimum membership). In one embodiment, the activation degree of a rule, among other techniques, can be calculated by the product between all individual memberships. Thus, additional fuzzy data, which may be generated from crisp data in the fuzzification layer, reflects the membership degrees of that particular data sample to all possible clusters in your problem. Once again, the membership functions and fuzzy rules may be determined in advance and then included in the fuzzification layer for processing of crisp data and generation of fuzzy data inputs.

FIG. 5 is a schematic diagram illustrating a traditional autoencoder 500. The autoencoder 500 includes an input layer 502 with a same number of nodes as an output layer 504. A hidden layer 506 is positioned between the input layer 502 and the output layer 504. In one embodiment, the autoencoder 500 may be trained until the output of the output layer 504 matches or reaches a required level of approximation to the input at the input layer 502.

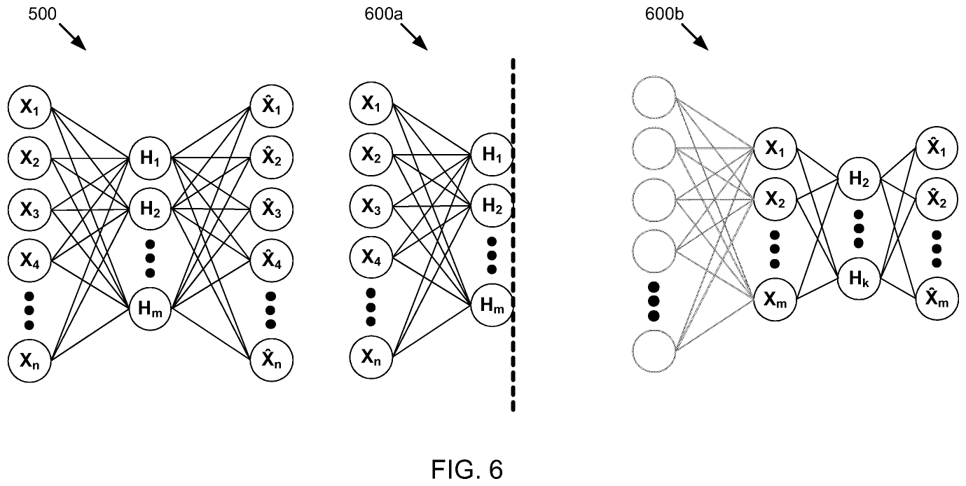

FIG. 6 illustrates creation of a deep stack of autoencoders. An autoencoder 500 may be trained until the output sufficiently matches or approximates an input. Then, an output layer of the autoencoder 500 is removed as shown in 600a and an additional auto encoder 600b is added. The additional auto encoder 600b uses the hidden layer of the previous autoencoder 500 as an input layer. The additional autoencoder 600b may then be trained to produce an output substantially matching or approximating an input. This process of training, dismissing the output layer, and adding an additional layer may be repeated as many times as needed to significantly reduce dimensionality. The training and addition of autoencoder layers may be performed with a fuzzification layer (such as that shown in FIG. 1) in place to receive crisp data and generate fuzzy inputs for each sample during training.

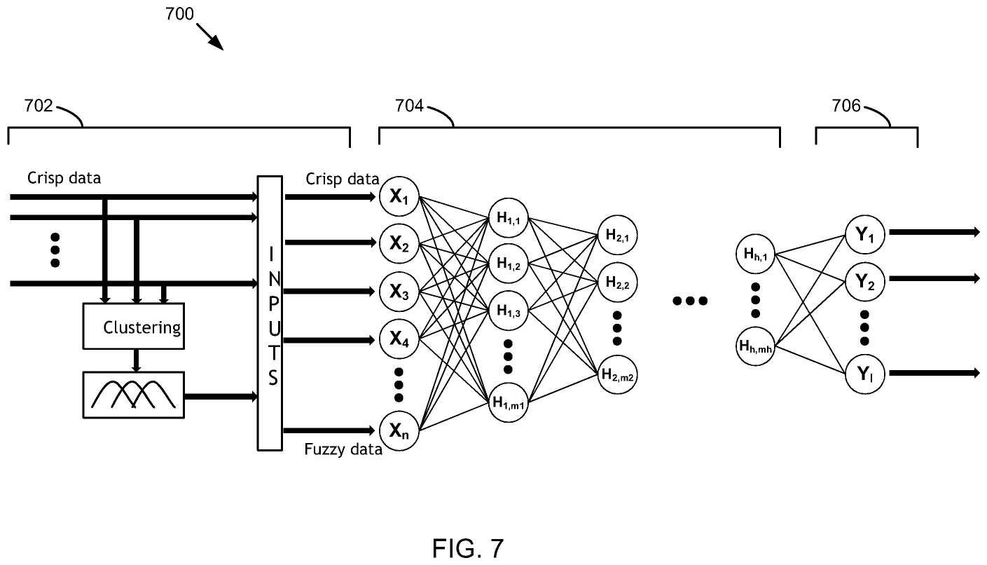

FIG. 7 illustrates a neural network 700 with a fuzzification layer 702. For example, after training auto encoders and/or classification layers as discussed in relation to the previous figures, the resulting stack of autoencoders may have a structure similar to the neural network 700. In one embodiment, after each autoencoder was trained separately with unlabeled data (unsupervised learning), one can use the available labeled data to fine-tune the stack of autoencoders (supervised learning). In one embodiment, when autoencoders are trained in an unsupervised manner, they will try to recreate the input at the output using reducing amount of features. Thus, during training the auto encoders will try to do drive the output to be as close as possible from the input, without any external feedback about its output (no labeled data needed. In one embodiment, prior to training of autoencoders or use of the fuzzification layer 702, a set of training data is processed to produce clusters and membership functions. At least some this data may then be included in the fuzzification layer 702 for outputting fuzzy data for each sample to be input into an autoencoder during training or real-world use.

After training, the structure may include the fuzzification layer 702 and one or more auto encoder layers 704. A classification layer 706 (e.g. a softmax classifier) may be used at the end of the autoencoder layers 704 to back propagate the existing error between the estimated output (from the network) and actual output (from the labels). After this step, instead of only grouping similar data together, the autoencoder now has some information available about what the input actually means. This may be particularly useful when one has lots of unlabeled data but only few labeled samples. For example, for traffic sign classification, it is much easier to just drive around and collect hours of data with cameras than having to also manually label all instances of traffic signs, possibly including their locations and meanings. Embodiments discussed herein may enable high accuracy training in this situation even if only a relatively small amount of the traffic signs are actually labeled.

Embodiments disclosed herein may provide significant benefit and utility in machine learning or other neural network use cases. For example, for feature extraction, large amounts of data may be represented with only limited features. For data compression, significantly reduced dimensions are achieved near the end of the deep stack of autoencoders leading to more simple classification layers and improved quality training and shorter training times. Embodiments also provide improved noise reduction. For example, when compressing data, the autoencoder gets rid of the less important part, which is usually noise. Embodiments also improve initialization of other neural networks. Specifically, instead of initializing the networks randomly, the autoencoder can group similar data together and be a powerful tool for convergence of networks. The fuzzy approach for autoencoder input can address and improve all of these uses, with the addition of being able to better represent the data in the same small amount of space, since it adds qualitative information to the data set. The fuzzy approach (fuzzy input generation) may especially improve with uncertainty (e.g. inputs never seen before during training—example of the previous page, ambiguities and noise).

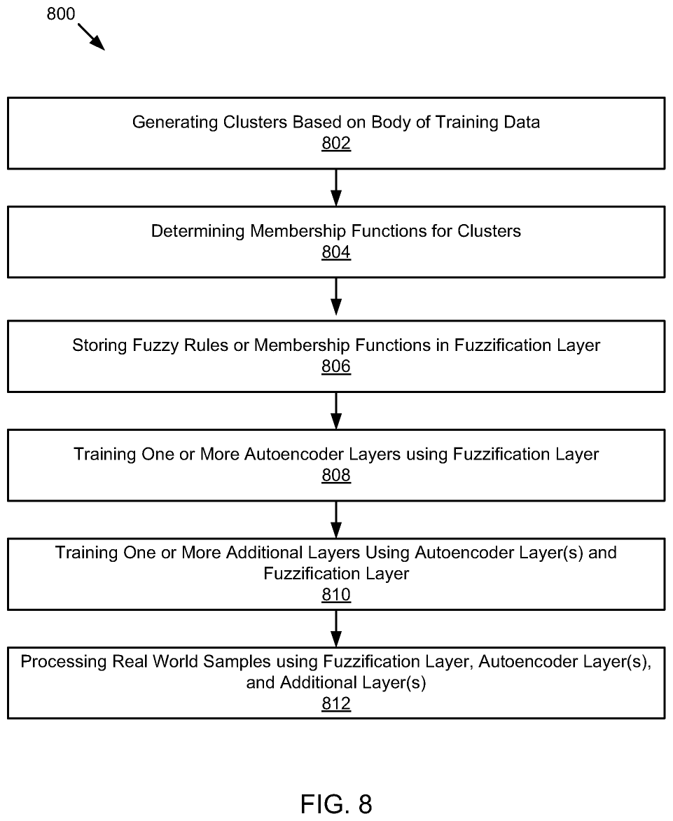

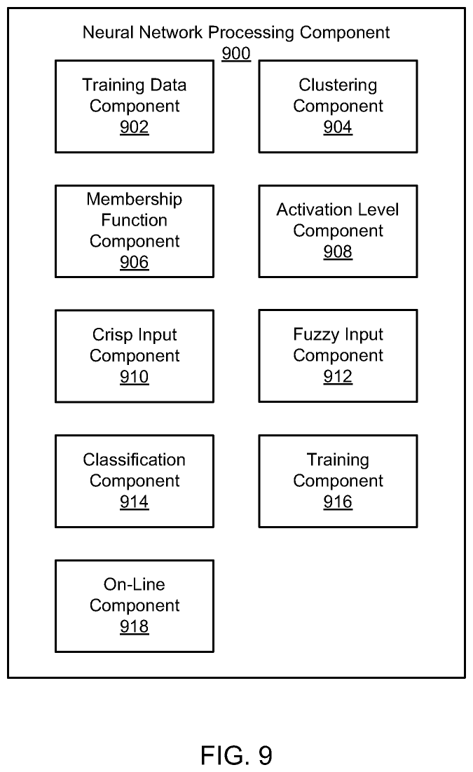

FIG. 8 is a schematic flow chart diagram illustrating a method 800 for training and processing data using a neural network with fuzzy input. The method 800 may be performed by one or more computing systems or by a neural network processing component, such as the neural network processing component 900 of FIG. 9.

The method 800 includes generating 802 clusters based on body of training data. For example, a clustering algorithm may be used to identify and generate parameters for one or more clusters identified within training data. The method 800 includes determining 804 membership functions for clusters. The method 800 includes storing 806 fuzzy rules or membership functions in fuzzification layer. For example, an equation or indication of the membership function may be stored in the fuzzification layer so that the fuzzification layer may be used to generate fuzzy inputs based on a single sample (a single sample may include a plurality of features). The method 800 includes training 808 one or more autoencoder layers using fuzzification layer. For example, training samples may be input one at a time into the fuzzification layer which then inputs the original training sample data (crisp data) and generated fuzzy inputs into an input column of an autoencoder. Back propagation may be used to train the autoencoders or autoencoder layers with the fuzzification layer in place. The method 800 includes training 810 one or more additional layers using autoencoder layer(s) and fuzzification layer. For example, after a deep stack of autoencoders has been produced one or more classification layers, or other layers, may be added and an output. Training may take place by inputting samples into the fuzzification layer and back propagating error to train the values in nodes of the additional layers and the nodes in the deep stack of autoencoders. The method 800 also includes processing 812 real world samples using fuzzification layer, autoencoder layer(s), and additional layer(s). For example, after the autoencoder layers and additional layers have been trained, the neural network may be used to provide classifications, predictions, or other output based on real world samples. The real world samples may be input to a fuzzification layer so that fuzzy data is generated as input even during the processing of real world data, in one embodiment.

In one embodiment, clustering may be performed on a large body of training data. After clustering and membership functions have been determined, the same samples may be used, one at a time, to train autoencoder layers using a fuzzification layer that generates fuzzy input based on the clustering and membership functions. Then, labeled training data may be used to train the autoencoder or additional layers (e.g., an output layer or classification layer). Thus training data may be used for determining parameters for a fuzzification layer to produce fuzzy data, for determining values for nodes in one or more autoencoder layers, and/or for determining values for nodes in an output, classification, or other layer.

Turning to FIG. 9, a schematic block diagram illustrating components of a neural network processing component 900, according to one embodiment, is shown. The neural network processing component 900 may provide training of neural networks and/or processing of data using a neural network according to any of the embodiments or functionality discussed herein. The neural network processing component 900 includes a training data component 902, a clustering component 904, a membership function component 906, an activation level component 908, a crisp input component 910, a fuzzy input component 912, a classification component 914, a training component 916, and an on-line component 918. The components 902-918 are given by way of illustration only and may not all be included in all embodiments. In fact, some embodiments may include only one or any combination of two or more of the components 902-918. For example, some of the components 902-918 may be located outside or separate from the neural network processing component 900.

The training data component 902 is configured to obtain raw data including a plurality of training samples. For example, the training data component 902 may store or retrieve training data from storage. The clustering component 904 is configured to identify a plurality of groups or clusters within the raw data. The clustering component 904 may perform clustering on a full body of training data (e.g., a plurality of samples of training data) to determine how the data is clustered. The membership function component 906 is configured to determine a plurality of membership functions, wherein the plurality of membership functions include a membership function for each of the plurality of groups or clusters. In one embodiment, the cluster information or membership function is stored in a fuzzification layer or input layer for a neural network. The clustering and/or membership function information may be determined in advance of any training of neural networks of an autoencoder or other node of the neural network.

The activation level component 908 is configured to determine an activation level for at least one membership function based on features of a sample. For example, the activation level component 908 may determine an activation level based on a fuzzy rule or other parameter determined by the membership function component 906. The crisp input component 910 is configured to input features of the sample into a first set of input nodes of an autoencoder and the fuzzy input component 912 is configured to input the activation level into a second set of input nodes of the autoencoder. For example, the crisp and fuzzy input may be inputted on a sample by sample basis into an input node of a neural network. In one embodiment, a fuzzification layer includes the activation level component 908, the crisp input component 910, and the fuzzy input component 912. Thus, every sample (with a plurality of features) during training or online use may be processed by the activation level component 908, the crisp input component 910, and the fuzzy input component 912 to provide input to a neural network.

The classification component 914 is configured to process an output from an auto encoder layer and to generate and output a classification using a classification layer. The classification layer may be positioned at or near an output of a deep stack of autoencoders to provide a classification of a sample input to the deep stack of autoencoders. In one embodiment, the classification component 914, and other nodes of a neural network may be trained using back propagation to provide a classification based on labeled sample data.

The training component 916 is a training component configured to cause the activation level component, crisp input component, and fuzzy input component to operate on the training samples during training of one or more autoencoder levels. For example, the fuzzification layer may be used during training of one or more autoencoder layers and/or during training using labeled data. The on-line component 918 is configured to cause the activation level component, crisp input component, and fuzzy input component to process the real world data for input to a neural network including one or more autoencoder levels. For example, the fuzzification layer may be used to processed real world samples to produce fuzzy data for input to a neural network. In one embodiment, the clustering component 904 and membership function component 906 may not be used during on-line processing of data by a neural network with a fuzzification layer.

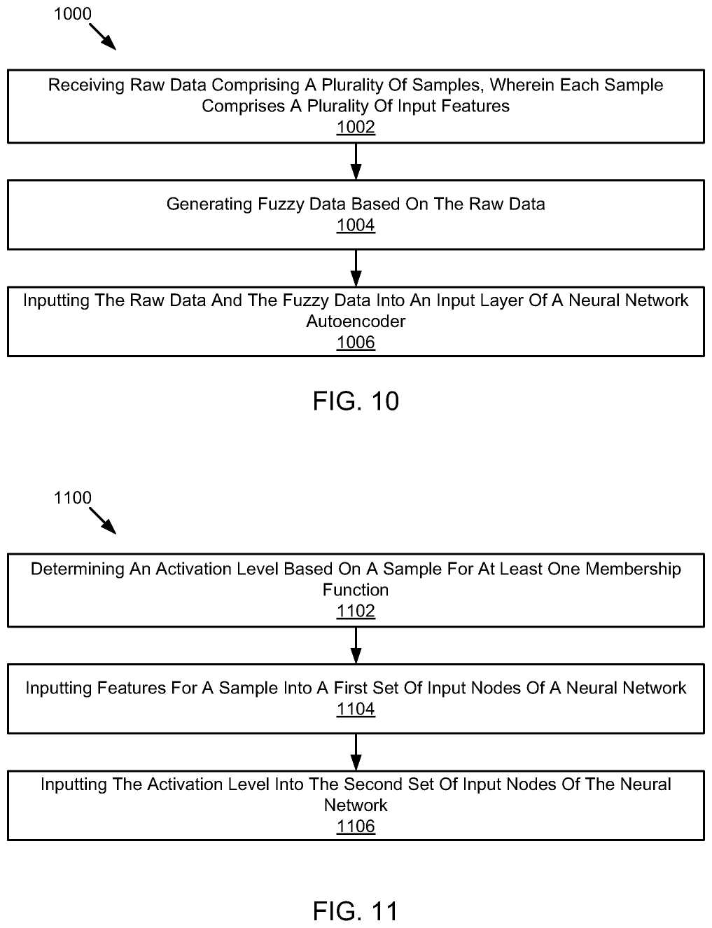

FIG. 10 is a schematic flow chart diagram illustrating a method 1000 for reducing dimensionality and improving neural network operation in light of uncertainty or noise. The method 1000 may be performed by a computing system or a neural network processing component, such as the neural network processing component 900 of FIG. 9.

The method begins and a neural network processing component 900 receives 1002 raw data comprising a plurality of samples, wherein each sample comprises a plurality of input features. An activation level component 908 generates 1004 fuzzy data based on the raw data. For example, the fuzzy data may include an activation level for a membership function or cluster. A crisp input component 910 and fuzzy input component 912 input 1006 the raw data and the fuzzy data into an input layer of a neural network autoencoder.

FIG. 11 is a schematic flow chart diagram illustrating a method 1100 for processing data using a neural network. The method 1100 may be used during training and/or processing of real world inputs. The method 1100 may be performed by a computing system or a neural network processing component, such as the neural network processing component 900 of FIG. 9.

The method 1100 begins and an activation level component 908 determines 1102 an activation level based on a sample for at least one membership function, wherein the membership function corresponds to a group or cluster determined based on training data. A crisp input component 910 inputs 1104 features for a sample into a first set of input nodes of a neural network. In one embodiment, the neural network includes one or more autoencoder layers and an input layer having the first set of input nodes and a second set of input nodes. A fuzzy input component 912 inputs 1106 the activation level into the second set of input nodes of the neural network.

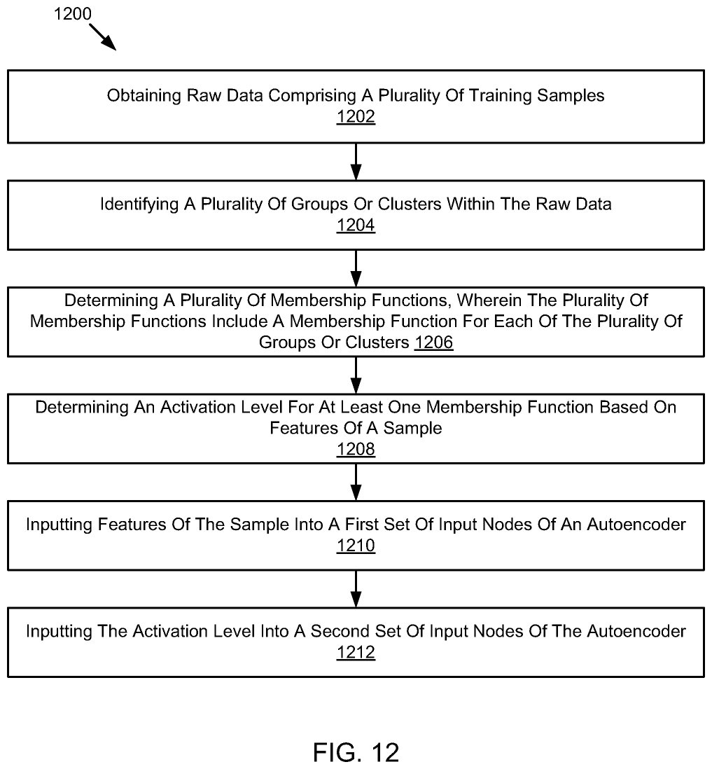

FIG. 12 is a schematic flow chart diagram illustrating a method 1200 for processing data using a neural network. The method 1200 may be used during training and/or processing of real world inputs. The method 1200 may be performed by a computing system or a neural network processing component, such as the neural network processing component 900 of FIG. 9.

The method 1200 begins a training data component 902 obtains 1202 raw data including a plurality of training samples. A clustering component 904 identifies 1204 a plurality of groups or clusters within the raw data. A membership function component 906 determines 1206 a plurality of membership functions, wherein the plurality of membership functions include a membership function for each of the plurality of groups or clusters. An activation level component 908 determines 1208 an activation level for at least one membership function based on features of a sample. A crisp input component 910 inputs 1210 features of the sample into a first set of input nodes of an autoencoder. A fuzzy input component 912 inputs 1212 the activation level into a second set of input nodes of the autoencoder.

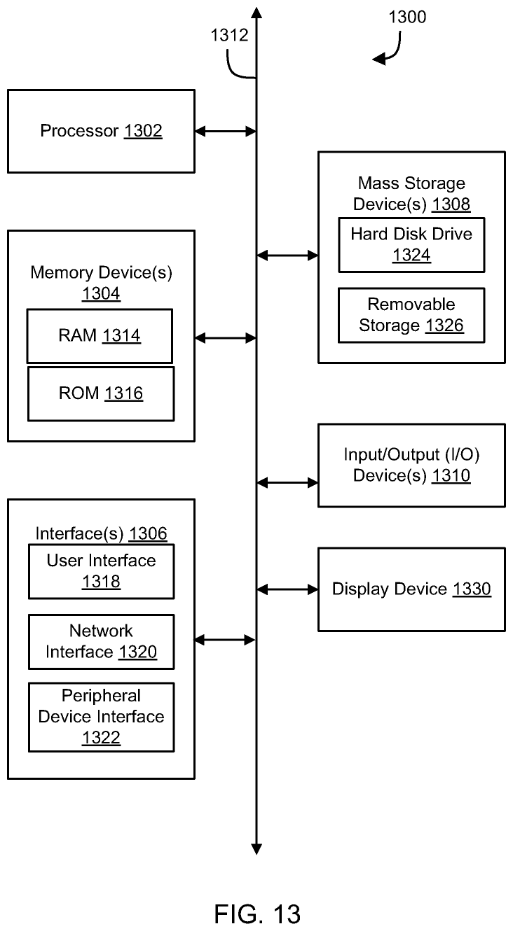

Referring now to FIG. 13, a block diagram of an example computing device 1300 is illustrated. Computing device 1300 may be used to perform various procedures, such as those discussed herein. Computing device 1300 can function as a neural network processing component 900, or the like. Computing device 1300 can perform various functions as discussed herein, such as the training, clustering, fuzzification, and processing functionality described herein. Computing device 1300 can be any of a wide variety of computing devices, such as a desktop computer, in-dash vehicle computer, vehicle control system, a notebook computer, a server computer, a handheld computer, tablet computer and the like.

Computing device 1300 includes one or more processor(s) 1302, one or more memory device(s) 1304, one or more interface(s) 1306, one or more mass storage device(s) 1308, one or more Input/Output (I/O) device(s) 1310, and a display device 1330 all of which are coupled to a bus 1312. Processor(s) 1302 include one or more processors or controllers that execute instructions stored in memory device(s) 1304 and/or mass storage device(s) 1308. Processor(s) 1302 may also include various types of computer-readable media, such as cache memory.

Memory device(s) 1304 include various computer-readable media, such as volatile memory (e.g., random access memory (RAM) 1314) and/or nonvolatile memory (e.g., read-only memory (ROM) 1316). Memory device(s) 1304 may also include rewritable ROM, such as Flash memory.

Mass storage device(s) 1308 include various computer readable media, such as magnetic tapes, magnetic disks, optical disks, solid-state memory (e.g., Flash memory), and so forth. As shown in FIG. 13, a particular mass storage device is a hard disk drive 1324. Various drives may also be included in mass storage device(s) 1308 to enable reading from and/or writing to the various computer readable media. Mass storage device(s) 1308 include removable media 1326 and/or non-removable media.

I/O device(s) 1310 include various devices that allow data and/or other information to be input to or retrieved from computing device 1300. Example I/O device(s) 1310 include cursor control devices, keyboards, keypads, microphones, monitors or other display devices, speakers, printers, network interface cards, modems, and the like.

Display device 1330 includes any type of device capable of displaying information to one or more users of computing device 1300. Examples of display device 1330 include a monitor, display terminal, video projection device, and the like.

Interface(s) 1306 include various interfaces that allow computing device 1300 to interact with other systems, devices, or computing environments. Example interface(s) 1306 may include any number of different network interfaces 1320, such as interfaces to local area networks (LANs), wide area networks (WANs), wireless networks, and the Internet. Other interface(s) include user interface 1318 and peripheral device interface 1322. The interface(s) 1306 may also include one or more user interface elements 1318. The interface(s) 1306 may also include one or more peripheral interfaces such as interfaces for printers, pointing devices (mice, track pad, or any suitable user interface now known to those of ordinary skill in the field, or later discovered), keyboards, and the like.

Bus 1312 allows processor(s) 1302, memory device(s) 1304, interface(s) 1306, mass storage device(s) 1308, and I/O device(s) 1310 to communicate with one another, as well as other devices or components coupled to bus 1312. Bus 1312 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 1300, and are executed by processor(s) 1302. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### Examples

The following examples pertain to further embodiments.

Example 1 is a method for reducing dimensionality and improving neural network operation in light of uncertainty or noise. The method includes receiving raw data including a plurality of samples, wherein each sample includes a plurality of input features. The method includes generating fuzzy data based on the raw data. The method includes inputting the raw data and the fuzzy data into an input layer of a neural network autoencoder.

In Example 2, generating the fuzzy data as in Example 1 includes determining a plurality of clusters based on a body of training data including a plurality of samples.

In Example 3, generating the fuzzy data as in Example 2 further includes generating a plurality of membership functions, wherein the plurality of membership functions includes a membership function for each of the plurality of clusters.

In Example 4, generating the fuzzy data as in Example 3 includes calculating a degree of activation for one or more of the plurality of membership functions for a specific sample, wherein the specific sample includes a training sample or a real-world sample.

In Example 5, inputting the fuzzy data as in Example 4 includes inputting the degree of activation for one or more of the plurality of membership functions into one or more input nodes in an input layer of the autoencoder.

In Example 6, generating the fuzzy data as in Example 1 includes calculating a degree of activation for one or more membership functions determined based on training data, wherein the specific sample includes a training sample or a real-world sample.

In Example 7, inputting the fuzzy data as in any of Examples 1 or 6 includes inputting the inputting the degree of activation for one or more of the plurality of membership functions into one or more input nodes in an input layer of the autoencoder.

In Example 8, inputting the raw data and the fuzzy data as in any of Examples 1-7 includes inputting during training of autoencoder.

In Example 9, a method as in any of Examples 1-8 further includes removing an output layer of the autoencoder and adding one or more additional neural network layers and training remaining autoencoder layers and the one or more additional neural network layers for a desired output.

In Example 10, the one or more additional neural network layers as in Example 9 include one or more classification layers and wherein the desired output includes a classification.

In Example 11, a method as in any of Examples 1-10 further includes stacking one or more autoencoder layers during training to create a deep stack of auto encoders.

Example 12 is a system that includes a training data component, a clustering component, a membership function component, an activation level component, a crisp input component, and a fuzzy input component. The training data component is configured to obtain raw data including a plurality of training samples. The clustering component is configured to identify a plurality of groups or clusters within the raw data. The membership function component is configured to determine a plurality of membership functions, wherein the plurality of membership functions include a membership function for each of the plurality of groups or clusters. The activation level component is configured to determine an activation level for at least one membership function based on features of a sample. The crisp input component is configured to input features of the sample into a first set of input nodes of an autoencoder. The fuzzy input component is configured to input the activation level into a second set of input nodes of the autoencoder.

In Example 13, the sample as in Example 12 includes a training sample of the plurality of training samples. The system further including a training component configured to cause the activation level component, crisp input component, and fuzzy input component to operate on the training samples during training of one or more autoencoder levels.

In Example 14, the sample as in Example 12 includes a real-world sample. The system further including an on-line component configured to gather the real world sample. The on-line component is further configured to cause the activation level component, crisp input component, and fuzzy input component to process the real world data for input to a neural network including one or more autoencoder levels.

In Example 15, the system as in any of Examples 12-14 further includes a classification component configured to process an output from an auto encoder layer and to generate and output a classification using a classification layer, the classification layer including one or more nodes.

In Example 16, the crisp input component and the fuzzy input component as in any of Examples 12-15 are configured to output to an input layer of a neural network, the neural network including a plurality of auto-encoder layers.

In Example 17, the neural network as in Example 16 further includes one or more classification layers, wherein the classification layers provide an output indicating a classification for crisp input of a sample.

Example 18 is computer readable storage media storing instructions that, when executed by one or more processors, cause the one or more processors to determine an activation level based on a sample for at least one membership function, wherein the membership function corresponds to a group or cluster determined based on training data. The instructions cause the one or more processors to input features for a sample into a first set of input nodes of a neural network, wherein the neural network includes one or more autoencoder layers and an input layer including the first set of input nodes and a second set of input nodes. The instructions cause the one or more processors to input the activation level into the second set of input nodes of the neural network.

In Example 19, the instructions as in Example 18 further cause the one or more processors to determine a plurality of groups or clusters based on the training data, wherein the plurality of groups or clusters include the group or cluster.

In Example 20, the instructions as in Example 19 further cause the one or more processors to generate a plurality of membership functions for the plurality of groups or clusters, wherein the plurality of membership functions include the membership function.

Example 21 is a system or device that includes means for implementing a method or realizing a system or apparatus in any of Examples 1-20.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for reducing dimensionality and improving neural network operation in light of uncertainty or noise, the method comprising:
receiving raw data comprising a plurality of samples, wherein each sample comprises a plurality of input features;
generating fuzzy data based on the raw data; and
inputting the raw data and the fuzzy data into an input layer of a neural network autoencoder.

2. The method of claim 1, wherein generating the fuzzy data comprises determining a plurality of clusters based on a body of training data comprising a plurality of samples.

3. The method of claim 2, wherein generating the fuzzy data further comprises generating a plurality of membership functions, wherein the plurality of membership functions comprises a membership function for each of the plurality of clusters.

4. The method of claim 3, wherein generating the fuzzy data comprises calculating a degree of activation for one or more of the plurality of membership functions for a specific sample, wherein the specific sample comprises a training sample or a real-world sample.

5. The method of claim 4, wherein inputting the fuzzy data comprises inputting the degree of activation for one or more of the plurality of membership functions into one or more input nodes in an input layer of the autoencoder.

6. The method of claim 1, wherein generating the fuzzy data comprises calculating a degree of activation for one or more membership functions determined based on training data, wherein the specific sample comprises a training sample or a real-world sample.

7. The method of claim 6, wherein inputting the fuzzy data comprises inputting the degree of activation for one or more of the plurality of membership functions into one or more input nodes in an input layer of the autoencoder.

8. The method of claim 1, wherein inputting the raw data and the fuzzy data comprises inputting during training of autoencoder.

9. The method of claim 1, further comprising:
removing an output layer of the autoencoder and adding one or more additional neural network layers; and
training remaining autoencoder layers and the one or more additional neural network layers for a desired output.

10. The method of claim 9, wherein the one or more additional neural network layers comprise one or more classification layers and wherein the desired output comprises a classification.

11. The method of claim 1, further comprising stacking one or more autoencoder layers during training to create a deep stack of auto encoders.

12. A system comprising
a training data component configured to obtain raw data comprising a plurality of training samples;
a clustering component configured to identify a plurality of groups or clusters within the raw data;
a membership function component configured to determine a plurality of membership functions, wherein the plurality of membership functions comprise a membership function for each of the plurality of groups or clusters;
an activation level component configured to determine an activation level for at least one membership function based on features of a sample;
a crisp input component configured to input features of the sample into a first set of input nodes of an autoencoder; and
a fuzzy input component configured to input the activation level into a second set of input nodes of the autoencoder.

13. The system of claim 12, wherein the sample comprises a training sample of the plurality of training samples, the system further comprising a training component configured to cause the activation level component, crisp input component, and fuzzy input component to operate on the training samples during training of one or more autoencoder levels.

14. The system of claim 12, wherein the sample comprises a real-world sample, the system further comprising an on-line component configured to gather the real world sample, the on-line component further configured to cause the activation level component, crisp input component, and fuzzy input component to process the real world data for input to a neural network comprising one or more autoencoder levels.

15. The system of claim 12, further comprising a classification component configured to process an output from an auto encoder layer and to generate and output a classification using a classification layer, the classification layer comprising two or more nodes.

16. The system of claim 12, wherein input the crisp input component and the fuzzy input component are configured to output to an input layer of a neural network, the neural network comprising a plurality of auto-encoder layers.

17. The system of claim 16, wherein the neural network further comprises a classification layer, wherein the classification layer provides an output indicating a classification for crisp input of a sample.

18. Computer readable storage media storing instructions that, when executed by one or more processors, cause the one or more processors to:
determine an activation level based on a sample for at least one membership function, wherein the membership function corresponds to a group or cluster determined based on training data;
input features for a sample into a first set of input nodes of a neural network, wherein the neural network comprises one or more autoencoder layers and an input layer comprising the first set of input nodes and a second set of input nodes; and
input the activation level into the second set of input nodes of the neural network.

19. The computer readable storage media of claim 18, wherein the instructions further cause the one or more processors to determine a plurality of groups or clusters based on the training data, wherein the plurality of groups or clusters comprise the group or cluster.

20. The computer readable storage media of claim 19, wherein the instructions further cause the one or more processors to generate a plurality of membership functions for the plurality of groups or clusters, wherein the plurality of membership functions comprise the membership function.
